(19) United States
(12) Patent Application Publication
(10) Pub. No.: US 2002/0185443 A1
(43) Pub. Date: Dec. 12, 2002

(54) Process for preparing heterodisperse chelating resins

(76) Inventors: Reinhold Klipper, Koln (DE); Rudiger Seidel, Leverkusen (DE); Bruno Hees, Langenfeld (DE); Dieter Irmscher, Bergisch Gladbach (DE); Bernhard Lehmann, Aachen (DE); Holger Lutjens, Koln (DE); Ulrich Schnegg, Leverkusen (DE); Wolfgang Zarges, Koln (DE)

Correspondence Address: BAYER CORPORATION, PATENT DEPARTMENT, 100 BAYER ROAD, PITTSBURGH, PA, 15205, US

(21) Appl. No.: 10/134,717

(22) Filed: Apr. 29, 2002

(30) Foreign Application Priority Data
Apr. 30, 2001 (DE) 10121163.5

(51) Int. Cl. C02F 1/42

(52) U.S. Cl. 210/688

(57) ABSTRACT

The object of the present invention is a process for preparing novel heterodisperse chelating resins having chelating functional groups, and their use for adsorbing metal compounds, in particular alkaline earth metals, heavy metal compounds and precious metal compounds, and also for extracting alkaline earth metals from saline solutions derived from alkali metal chloride electrolysis, and also in hydrometallurgy.

### BACKGROUND OF THE INVENTION

The present invention relates to an improved process for preparing novel heterodisperse ion exchangers having chelating functional groups, hereinafter termed heterodisperse chelating resins, and also to their use.

There are currently two classes of important preparation processes for bead polymers or ion exchangers: a conventional process that gives heterodisperse resins and a process requiring more complicated apparatus and giving monodisperse resins. Depending on requirements, a variety of resin types can therefore be prepared, and the two versions of the process therefore exist alongside one another. However, the present application relates to only one version, namely that for preparing heterodisperse chelating resins.

Ion exchangers having chelating functional groups are known. For example, descriptions of ion-exchanger resins having aminoalkylenephosphonic acid groups and processes for their preparation and the properties of these resins, such as adsorbing alkaline earth metal ions from concentrated alkali metal salt solutions (e.g., brines) or removing heavy metal ions from aqueous solutions, can be found in U.S. Pat. No. 4,002,564 or EP-A 87,934.

Chelating resins having iminoacetic acid groups are also described by Rudolf Hering, Chelatbildende lonenaustauscher [Chelate-forming Ion Exchangers], Akademie Verlag, Berlin 1967, pp. 51 et seq. This reference also includes examples of other types of chelating resin.

A widespread industrial application of ion exchangers having chelating groups is the removal of alkaline earth metal ions from concentrated alkali metal salt solutions. Prior to use, the chelating functional groups, mostly in the form of aminoalkylenephosphonic acid groups or iminoacetic acid groups, in the ion exchanger are in the sodium salt form. During removal of the alkaline earth metals from saline solutions, some of the sodium ions in the ion exchanger are exchanged for alkaline earth metal ions. Once the ion exchanger has become exhausted, treatment with mineral acids takes place to remove the alkaline earth metals, and this is followed by treatment (regeneration) with sodium hydroxide solution to convert the chelating groups into the Na form. It is in this regenerated form that the chelating resin is used to remove alkaline earth metals from the saline solution.

The volume change that occurs during the use of chelating resins and their regeneration can be up to about 60 percent. The beads shrink and swell and are therefore exposed to considerable osmotic and mechanic stress. This stress can cause bead fracture. Bead fragments then provide an obstacle to the liquid to be treated with the chelating resin and flowing through the column and increase pressure loss and cause contamination of the liquid to be purified. In many applications the chelating resins must be regenerated daily. However, since their operating time is intended to be number of years, and therefore many hundreds of regenerations are needed during the life of a chelating resin, it is desirable to develop heterodisperse chelating resins which meet these high requirements.

There is a need for heterodisperse chelating resins that are so stable, mechanically and osmotically, that very little bead fracture occurs even after many years of use with frequent regeneration.

Various measures have been described for improving the stability of chelating resins having aminoalkylenephosphonic acid groups.

EP-A 87,934 describes the preparation, by chloromethylation, of chelating resins functionalized by alkylaminophosphonic acid groups. To increase stability, it proposes the use of macroporous crosslinked vinyl-aromatic bead polymers with certain physical properties (a certain density, a certain particle size, a certain porosity, a certain toluene swelling volume) as bead polymer starting material. The properties mentioned for the bead polymer starting materials here are within certain narrow ranges; there is no description in any detail of the initiator used during the polymerization.

The manner of chloromethylation in EP-A 87,934 is such that the content of chlorine bonded to the resin has a limit. The aim is to limit the exchange capacity of the resin, since post-crosslinking arises if the degree of functionalization is higher. Since this arises both during the chloromethylation and during the phosphorylation of the aminated resin, the stability of the resin with respect to osmotic shock is inevitably impaired. In addition, the duration and the temperature of the alkylphosphonation reaction must be controlled so as to retain the limit on the exchange capacity of the resultant resin. The technical problem is therefore not satisfactorily solved, in that resin capacity is sacrificed to increase osmotic strength.

EP-A 355,007 describes a process for preparing chelating resins having alkylaminophosphonic acid groups by the phthalimide process. The chelating resins are prepared from crosslinked vinylaromatic bead polymers. Their preparation is described in U.S. Pat. Nos. 3,989,650, 3,882,053, and 4,077,918.

The process described in EP-A 355,007 leads to stabler resins than those of EP-A 87,934. This is achieved by reacting the macroporous, aminomethylated crosslinked vinylaromatic resins with formaldehyde and phosphorus(III) compounds in the presence of sulfuric acid, the amount of these being used giving a concentration of at least 20% by weight, based on the total weight of the liquid phase of the reaction mixture.

The use of sulfuric acid instead of hydrochloric acid also avoids formation of highly toxic chloromethyl ethers during the phosphorylation.

However, the stability improvements achieved by the measures mentioned are limited. Although the resultant resins exhibit adequate swelling resistance for a short time—during 30 conversions—this is insufficient for the long usage times demanded in industry, which requires 200 conversions or more.

Known chelating resins having aminoalkylenephosphonic acid groups or iminodiacetic acid groups have the overall disadvantage of having either unsatisfactory osmotic stability (swelling resistance) or having inadequate capacity for the ions to be absorbed.

It is an object of the present invention, therefore, to use the phthalimide process to prepare heterodisperse chelating resins with high stability at high capacity, to ensure that they can be used for many years with the associated repeated regeneration, and without any use of toxicologically questionable starting materials.

Surprisingly, it has now been found that ion exchangers having chelating functional groups, particularly aminoalkylenephosphonic acid groups or iminoacetic acid groups, and markedly improved swelling resistance in the 200-cycle test, and also high exchange capacity, are obtained when grafting initiators, particularly peroxycarbonates, peroxyesters, or peresters, alone or in combination, are used in the suspension polymerization process to prepare the heterogeneous bead polymers which serve as matrix.

The macroporous bead polymers obtainable by using the grafting initiators are then reacted by the phthalimide process to give aminomethylated crosslinked vinylaromatic resins, which are then reacted, for example, with formaldehyde and phosphorus(III) compounds in the presence of sulfuric acid.

### SUMMARY OF THE INVENTION

The present invention therefore provides a process for preparing heterodisperse chelating resins comprising

(a) reacting monomer droplets made from at least one monovinylaromatic compound and at least one polyvinylaromatic compound, from a porogen, and from an initiator or an initiator combination, wherein the initiator is a peroxycarbonate, a perester, or a peroxyester, to give a heterodisperse crosslinked bead polymer,

(b) amidomethylating the heterodisperse crosslinked bead polymer with phthalimide derivatives,

(c) reacting the amidomethylated bead polymer to give an aminomethylated bead polymer, and

(d) functionalizing the aminomethylated bead polymer to give a bead polymer containing chelating groups.

Where appropriate, after step (d) the heterodisperse chelating resin is converted using a base, preferably sodium hydroxide solution.

### DETAILED DESCRIPTION OF THE INVENTION

Step (a) of the process uses at least one monovinylaromatic compound and at least one polyvinylaromatic compound. However, it is also possible to use mixtures of two or more monovinylaromatic compounds or mixtures of two or more polyvinylaromatic compounds.

For the purposes of the present invention, the monovinylaromatic compounds preferably used in step (a) of the process are monoethylenically unsaturated compounds, such as styrene, vinyltoluene, ethylstyrene, α-methylstyrene, chlorostyrene, chloromethylstyrene, alkyl acrylates, or alkyl methacrylates. It is particularly preferable to use styrene or mixtures of styrene with the abovementioned monomers.

The monovinylaromatic compounds or mixtures of styrene with the abovementioned monomers form an initial charge for the polymerization. The amounts of the other components, such as the polyvinylaromatic compounds, the initiators, or, where appropriate, other additives are based on the monovinylaromatic compound and, respectively, related to the total of monomer and crosslinker.

For the purposes of the present invention, preferred polyvinylaromatic compounds of step (a) of the process are multifunctional ethylenically unsaturated compounds, such as divinylbenzene, divinyltoluene, trivinylbenzene, divinylnaphthaline, trivinyinaphthaline, 1,7-octadiene, 1,5-hexadiene, ethyleneglycol dimethacrylate, trimethylolpropane trimethacrylate, and allyl methacrylate.

The amounts generally used of the polyvinylaromatic compounds are from 1 to 20% by weight (preferably from 2 to 12% by weight, particularly preferably from 4 to 10% by weight), based on the monomer or its mixture with other monomers. The nature of the polyvinylaromatic compounds (crosslinker) is selected with regard to the subsequent use of the bead polymer. Divinylbenzene is suitable in many cases. For most applications commercial qualities of divinylbenzene are adequate. These comprise ethylvinylbenzene alongside the isomers of divinylbenzene.

The crosslinked base polymers may be prepared by known methods of suspension polymerization; cf. Ullmann's Encyclopedia of Industrial Chemistry, 5^{th} ed., Vol. A21, 363-373, VCH Verlagsgesellschaft mbH, Weinheim 1992. The water-insoluble monomer/crosslinker mixture is added to an aqueous phase that preferably comprises at least one protective colloid to stabilize the monomer/crosslinker droplets in the disperse phase and the resultant bead polymers.

Preferred protective colloids are naturally occurring or synthetic water-soluble polymers, such as gelatin, starch, polyvinyl alcohol, polyvinylpyrrolidone, polyacrylic acid, polymethacrylic acid, or copolymers of (meth)acrylic acid or of (meth)acrylic esters. Cellulose derivatives are also highly suitable, particularly cellulose esters and cellulose ethers, such as methylhydroxyethylcellulose, methylhydroxypropylcellulose, hydroxyethylcellulose, or carboxymethylcellulose. The amount used of the protective colloids is generally from 0.02 to 1% by weight (preferably from 0.05 to 0.3% by weight), based on the aqueous phase.

The ratio of aqueous phase to organic phase by weight is preferably in the range from 0.5 to 20, particularly from 0.75 to 5.

The grafting initiators to be used in step (a) of the process according to the invention are described in Journal of Polymer Science, Polymer Chemistry Edition Vol. 14, No. 6 June 1976, pp 1495 to 1511.

These may be used alone or in combination during the bead polymerization. Grafting initiators that may be used for the purposes of the present invention are peroxycarbonates, peroxyesters, or peresters. Particular preference is given to the use of tert-amylperoxy 2-ethylhexyl carbonate, tert-butylperoxy 3,5,5-trimethylhexanoate, tert-butylperoxy 2-ethylhexanoate, tert-butylperoxy isopropyl carbonate, tert-butylperoxy stearyl carbonate, tert-amylperoxy benzoate, or tert-butylperoxy benzoate.

The initiator/free-radical generators may be used in catalytic amounts, preferably from 0.01 to 2.5% by weight, particularly from 0.12 to 1.5% by weight, based on the total monomer and crosslinker.

To give the macroporous structure of the base polymers, porogens are added to the monomer/crosslinker mixture in step (a) of the process, the porogens being described by way of example in Seidl et al. Adv. Polym. Sci., Vol. 5 (1967), pp. 113 to 213. According to the invention, preferred porogens are aliphatic hydrocarbons, alcohols, esters, ethers, ketones, trialkylamines, and nitro compounds (particularly isododecane, isodecane, methyl isobutyl ketone, or methyl isobutyl carbinol) in amounts of from 1 to 150% by weight (preferably from 40 to 100% by weight, particularly from 50 to 80% by weight), based on the total of the monomer and crosslinker.

In one particular embodiment, the base polymers are prepared in step (a) of the process with a buffer system being present during the polymerization. Preference is given to buffer systems that adjust the pH of the aqueous phase at the start of the polymerization to a value of from 14 to 6, preferably from 12 to 8. Under these conditions, protective colloids having carboxylic acid groups are present partially or entirely in salt form. This has an advantageous effect on the action of the protective colloids. The concentration of the buffer in the aqueous phase is preferably from 0.5 to 500 mmol (particularly from 2.5 to 100 mmol) per liter of aqueous phase.

The organic phase may be distributed in the aqueous phase by stirring, the particle size of the resultant droplets being substantially dependent on the stirring rate.

The polymerization temperature in step (a) of the process depends on the decomposition temperature of the initiator used. It is generally from 50 to 150° C., preferably from 55 to 100° C. The polymerization takes from 0.5 hours to a few hours. The use of a temperature program in which the polymerization begins at low temperature, for example 60° C., and the reaction temperature is raised as the conversion proceeds in the polymerization has proven to be successful. After the polymerization, the polymer is isolated by conventional methods, such as filtering or decanting, and washed where appropriate.

Step (b) of the process begins by preparing the amidomethylating reagent, for example by dissolving phthalimide in a solvent and reacting it with formalin. A bis(phthalimidomethyl) ether is then formed from this mixture, with elimination of water. Where appropriate, the bis(phthalimidoethyl) ether can be reacted to give the phthalimidomethyl ester.

Solvents that may be used in step (b) of the process are inert solvents suitable for swelling the polymer, preferably chlorinated hydrocarbons, particularly preferably dichloroethane or methylene chloride.

Step (b) of the process condenses the bead polymer with phthalimide derivatives, the catalyst used being oleum, sulfuric acid, or sulfur trioxide.

The cleavage of the phthalic acid radical and thus the liberation of the aminomethyl group takes place in step (c) of the process through treatment of the phthalimidomethylated crosslinked bead polymer with aqueous or alcoholic solutions of an alkali metal hydroxide (such as sodium hydroxide or potassium hydroxide) at temperatures of from 100 to 250° C., preferably from 120 to 190° C. The concentration of the sodium hydroxide solution is in the range from 10 to 50% by weight, preferably from 20 to 40% by weight. This process permits the preparation of crosslinked bead polymers containing aminoalkyl groups and having a substitution level greater than 1 on the aromatic rings.

The resultant aminomethylated bead polymer is finally washed with the demineralized water until free from alkali metal.

Step (d) of the process prepares the ion exchangers of the invention by reacting the heterodisperse, crosslinked, vinylaromatic base polymer containing aminomethyl groups in suspension with compounds that give the functionalized amine chelating properties.

Preferred reagents used in step (d) of the process are chloroacetic acid or its derivatives, thiourea, or formalin combined with P-H compounds that (following a modified Mannich reaction, in suspension) are acidic, such as phosphorous acid, monoalkyl phosphites, or dialkyl phosphites, formalin combined with S-H compounds that are acidic, such as thioglycolic acid, alkyl mercaptans, or L-cysteine, or formalin combined with hydroxyquinoline or its derivatives, e.g., 7-(4-ethyl-1-methyloctyl)-8-hydroxyquinoline.

It is particularly preferable to use chloroacetic acid or formalin combined with P-H compounds that are acidic, such as phosphorous acid.

The suspension medium used is water or aqueous mineral acid. It is preferable to use water, aqueous hydrochloric acid, or aqueous sulfuric acid at concentrations of from 10 to 40% by weight, preferably from 20 to 35% by weight.

The present invention also provides the heterodisperse ion exchangers prepared by the process of the invention and having chelating groups, termed heterodisperse chelating resins hereinafter.

The present invention therefore also provides heterodisperse chelating resins obtainable by

(a) reacting monomer droplets made from at least one monovinylaromatic compound and at least one polyvinylaromatic compound, from a porogen, and from an initiator or an initiator combination, wherein the initiator is a peroxycarbonate, a perester, or a peroxyester, to give a heterodisperse crosslinked bead polymer,

(b) amidomethylating the heterodisperse crosslinked bead polymer with phthalimide derivatives,

(c) reacting the amidomethylated bead polymer to give an aminomethylated bead polymer, and

(d) functionalizing the aminomethylated bead polymer to give a chelating resin.

The process of the invention preferably gives heterodisperse chelating resins wherein chelating groups of the formula (I)

—(CH₂)ₙ—NR₁R₂ (I)

where

R₁ represents hydrogen or a CH₂—COOH or CH₂ P(O)(OH)₂ radical or

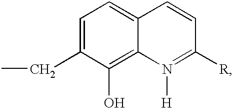

R₂ represents a CH₂COOH, CH₂P(O)(OH)₂, or

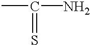

radical or

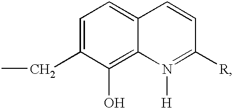

n represents the integer 1, 2, 3 or 4, and

R represents hydrogen or a branched or unbranched alkyl radical having up to 12 carbon atoms (preferably a branched or unbranched C₁-C₁₀-alkyl radical, particularly preferably a 1-methyloctyl radical),

form during step (d) of the process.

The heterodisperse chelating resins of the invention preferably have a macroporous structure resulting from the use of porogen.

The heterodisperse chelating resins prepared according to the invention are suitable either in the form prepared in the present invention or as powder resins, pastes, or compounds for use in hydrometallurgy, preferably for the adsorption of metals (particularly alkaline earth metals, heavy metals, or precious metals) or compounds of these metals, from aqueous solutions of organic liquids. The heterodisperse chelating resins prepared according to the invention are particularly suitable for removing alkaline earth metals, heavy metals, or precious metals from aqueous solutions (particularly from aqueous solutions of alkaline earth metals or of alkali metals), from saline solutions from alkali metal chloride electrolysis, from aqueous hydrochloric acids, from waste water, from flue gas scrubber effluent, from liquid or gaseous hydrocarbons, carboxylic acids, such as adipic acid, glutaric acid, or succinic acid, from natural gases, from natural gas condensates, or from mineral oils or halogenated hydrocarbons (such as chloro- or fluorohydrocarbons or fluorochlorohydrocarbons). The heterodisperse chelating resins of the invention are moreover suitable for removing alkaline earth metals from saline solutions as usually used in the electrolysis of alkali metal chlorides. The heterodisperse chelating resins of the invention are also suitable for removing heavy metals (particularly iron, cadmium, or lead) from substances that are reacted during electrolytic treatment, for example, dimerization of acrylonitrile to give adiponitrile.

The heterodisperse chelating resins prepared according to the invention are very particularly suitable for removing beryllium, magnesium, calcium, strontium, barium, mercury, iron, cobalt, nickel, copper, zinc, lead, cadmium, manganese, uranium, vanadium, elements of the platinum group, gold, or silver from the abovementioned solutions, liquids, or gases.

The heterodisperse chelating resins of the invention are moreover suitable for removing rhodium or elements of the platinum group, or catalyst residues comprising precious metal or rhodium, or gold, or silver, from organic solutions or solvents. The heterodisperse chelating resins of the invention are also suitable for removing gallium from sodium aluminate solutions (bauxite solutions) arising during aluminum extraction, and also for removing germanium from aqueous acidic solutions. Germanium is a trace element found in copper ores, silver ores, and zinc ores, and also in coal. The main industrial method of extracting germanium is from the ores germanite or renierite, by reacting GeO₂ with HCl to give Ge tetrachloride, which can easily be distilled. Repeated distillation removes all foreign substances.

Wet-chemical separation using the chelating resins described according to the invention is a substantially more cost-effective method.

However, the heterodisperse chelating resins prepared according to the invention may also be milled, giving powder, pastes, or compounds for use in hydrometallurgy. Provided with aminomethylphosphonic acid groups or other functional groups, and, where appropriate, combined with other chelating resins on support materials, the heterodisperse chelating resins according to the invention can absorb undesirable elements within an aqueous system. This method may be used, for example, to bind antimony, iron, cobalt, silver, tin, or nickel in batteries and thus prolong battery life.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used.

### EXAMPLES

### Example 1

1a) Preparation of Bead Polymer—use of Tert-Butylperoxy 2-Ethylhexanoate as Initiator

1112 ml of demineralized water, 150 ml of 2% strength by weight aqueous solution of methylhydroxyethylcellulose, and 7.5 g of disodium hydrogenphosphate×12 H₂O formed the initial charge in a polymerization reactor at room temperature. The entire solution was stirred for an hour at room temperature. The monomer mixture composed of 95.37 g of 80.53% purity by weight divinylbenzene, 864.63 g of styrene, 576 g of isododecane and 9.90 g of 97% purity by weight tert-butylperoxy 2-ethylhexanoate was then added. The mixture then stood for 20 minutes at room temperature and was then stirred for 30 minutes at room temperature, the stirring rate being 200 rpm (revolutions per minute). The mixture was heated to 70° C., stirred at 70° C. for a further 7 hours, then heated to 95° C. and stirred at 95° C. for a further 2 hours. After cooling, the bead polymer was filtered off and washed with water and dried for 48 hours at 80° C.

1b) Preparation of Amidomethylated Bead Polymer

1044.5 g of 1,2 dichloroethane, 310.2 g of phthalimide, and 216.7 g of 30.0% strength by weight formalin formed an initial charge at room temperature. The pH of the suspension was adjusted to 5.5 to 6 using sodium hydroxide solution. The water was then removed by distillation. 22.75 g of sulfuric acid were then metered in. The resultant water was removed by distillation. The mixture was cooled. 83.1 g of 65% strength oleum was metered in at 30° C., followed by 300.0 g of heterodisperse bead polymer from step 1a) of the process. The suspension was heated to 70° C. and stirred at this temperature for a further 6 hours. The reaction liquid was drawn off, demineralized water was metered in, and residual dichloroethane was removed by distillation.

Yield of amidomethylated bead polymer: 1220 ml

Composition by elemental analysis: carbon: 79.75% by weight, hydrogen: 5.4% by weight, nitrogen: 4.50% by weight

1c) Preparation of Aminomethylated Bead Polymer

1083 ml of 20% by weight sodium hydroxide solution were metered at room temperature into 1190 ml of amidomethylated bead polymer from Example 1b). The suspension was heated to 180° C. and stirred at this temperature for 8 hours. The resultant bead polymer was washed with demineralized water.

Yield of aminomethylated bead polymer: 1000 ml

Composition by elemental analysis: carbon: 83.9% by weight, nitrogen: 6.9% by weight, hydrogen: 8.0% by weight

Content of aminomethyl groups in resin: 1.92 mol/l

1d) Preparation of Chelating Resin Having Aminomethylphosphonic Acid Groups

426 ml of demineralized water and 820 ml of aminomethylated bead polymer from 1c) formed an initial charge at room temperature in a laboratory reactor. To this were added, over 15 minutes, at room temperature 289.3 g of a mixture of phosphorous acid and di- and monomethyl phosphite with an overall phosphorus content of 33.4% by weight. Stirring was continued for 30 minutes. 1052.5 g of monohydrate were then fed in at 60° C over 4 hours. The suspension was heated to reflux temperature. 462.9 g of 30% strength by weight formalin solution were fed in over one hour. Stirring was then continued at this temperature for a further 6 hours. After cooling, the resultant bead polymer was filtered off and washed with demineralized water. The washed bead polymer was transferred to a column and converted from the free hydrogen form to the disodium form by treatment with 4% strength by weight sodium hydroxide solution.

Yield of chelating resin having aminomethylphosphonic acid groups in sodium form: 1320 ml

Content of nitrogen in resin: 3.05% by weight; content of phosphorus in resin: 10.0% by weight

Total capacity content of aminomethylphosphonic acid groups in resin: 3.066 mol/l

### Example 2

### (Comparative Example Mixture Corresponding to EP-A 355,007)

2a) Preparation of Bead Polymer—use of Dibenzoyl Peroxide as Initiator 1112 ml of ultrahigh-purity water, 150 ml of a 2% strength by weight aqueous solution of methylhydroxyethylcellulose, and 7.5 g of disodium hydrogenphosphate×12 H₂O formed an initial charge at room temperature in a polymerization reactor. The entire solution was stirred for an hour at room temperature. The monomer mixture composed of 95.37 g of 80.53% purity by weight divinylbenzene, 864.63 g of styrene, 576 g of isododecane, and 7.70 g of 75% purity by weight dibenzoyl peroxide was then added. The mixture first stood for 20 minutes at room temperature and was then stirred for 30 minutes at room temperature, the stirrer speed being 200 rpm. The mixture was heated to 70° C., stirred at 70° C, for a further 7 hours, then heated to 95° C. and stirred at 95° C. for a further 2 hours. After cooling, the resultant bead polymer was filtered off and washed with water and dried at 80° C. for 48 hours.

2b) Preparation of Amidomethylated Bead Polymer

980.1 g of 1,2 dichloroethane, 291.1 g of phthalimide, and 199.0 g of 30.0% strength by weight formalin formed an initial charge at room temperature. The pH of the suspension was adjusted to 5.5 to 6 using sodium hydroxide solution. The water was then removed by distillation. 21.34 g of sulfuric acid were then metered in. The resultant water was removed by distillation. The mixture was cooled. 77.98 g of 65% strength by weight oleum was metered in at 30° C., followed by 320.1 g of heterodisperse bead polymer from step 2a) of the process. The suspension was heated to 70° C. C and stirred at this temperature for a further 6 hours. The reaction liquid was drawn off, demineralized water was metered in, and residual dichloroethane was removed by distillation.

Yield of amidomethylated bead polymer: 1020 ml

Composition by elemental analysis: carbon: 80.1% by weight; hydrogen:

5.6% by weight; nitrogen: 4.0% by weight

2c) Preparation of Aminomethylated Bead Polymer

910 ml of 20% strength by weight sodium hydroxide solution were metered at room temperature into 1000 ml of amidomethylated bead polymer from Example 2b). The suspension was heated to 180° C. and stirred at this temperature for 8 hours. The resultant bead polymer was washed with demineralized water.

Yield of aminomethylated bead polymer: 810 ml

Composition by elemental analysis: carbon: 84.75% by weight, nitrogen:

5.5% by weight, hydrogen: 8.9% by weight; oxygen: 2.0% by weight Content of aminomethyl groups in resin: 1.81 mol/l

2d) Preparation of Chelating Resin Having Aminomethylphosphonic Acid Groups

390 ml of demineralized water and 750 ml of aminomethylated bead polymer from 2c) formed an initial charge at room temperature in a laboratory reactor. To this were added, over 15 minutes, at room temperature 267.8 g of a mixture of phosphorous acid and di- and monomethyl phosphite with an overall phosphorus content of 33.4% by weight. Stirring was continued for 30 minutes. 1064.3 g of monohydrate were then fed in at 60° C., over 4 hours. The suspension was heated to reflux temperature. 468.1 g of 30% strength by weight formalin solution were fed in over one hour. Stirring was then continued at this temperature for a further 6 hours. After cooling, the resultant bead polymer was filtered off and washed with demineralized water. The washed bead polymer was transferred to a column and converted from the free hydrogen form to the disodium form by treatment with 4% strength by weight sodium hydroxide solution.

Yield of chelating resin having aminomethylphosphonic acid groups in sodium form: 1320 ml

Content of nitrogen in resin: 3.1% by weight; content of phosphorus in resin: 12.0% by weight

Total capacity content of aminomethylphosphonic acid groups in resin: 2.987 mol/l

Table 1 summarizes the experimental results:

| | | | Swelling resistance |
|---|---|---|---|
| | | | test 200 cycles, |
| | | Total capacity | number of |
| Experiment | Initiator | in mol/l | entire beads in % |
| 1 | tert-butylperoxy | 3.033 | 96 |
| | 2-ethylhexanoate | | |
| 2 | dibenzoyl peroxide | 2.987 | 30 |

Table 1 shows that use of initiators of peroxyester type, such as tert-butylperoxy 2-ethylhexanoate, give a heterodisperse chelating resin having aminomethylphosphonic acid groups of high stability and capacity. Use of peroxides of dibenzoylperoxide type gives a chelating resin having a aminomethylphosphonic acid groups of markedly poorer stability.

Test Methods:

The examples below characterize the heterodisperse chelating resins prepared according to the invention by the following properties:

1. Total capacity for sodium ions

2. Osmotic strength in the 200-cycle test

The methods used to determine these properties are as follows:

Determination of Total Capacity (TC) of Resin for Sodium Ions

100 ml of chelating resin to be tested are charged to a filter column and eluted with 3% strength by weight hydrochloric acid for 1.5 hours, followed by washing with demineralized water until the eluate is neutral.

In a column, 50 ml of chelating resin to be tested is treated with 0.1 N sodium hydroxide solution. The eluate is collected in a 250 ml measuring cylinder and the entire amount is titrated with 1 N hydrochloric acid, using methyl orange.

Feeding to the column continues until 250 ml of eluate is consumed from 24.5 to 25 ml of 1 N hydrochloric acid. Once the test has ended, the volume of exchanger in Na form is determined.

Total capacity (TC)=(X·25−ΣV)−3 in mol/l of exchanger

where

X=Number of eluate fractions

ΣV=Total consumption in ml of 1 N hydrochloric acid during eluate titration.

Determination of Osmotic Strength in the 200-Cycle Test

In a glass tube, 50 ml of the heterodisperse chelating resin to be tested are exposed to 200 conversion cycles each lasting one hour. The conversion cycle is composed of the following separate steps: conversion using 0.5 N hydrochloric acid, rinsing with demineralized water, conversion using 0.5 N sodium hydroxide solution, and rinsing with demineralized water. The number of undamaged beads remaining is then counted under a microscope.

Determination of amount of basic aminomethyl groups in amino-methylated crosslinked polystyrene bead polymers:

100 ml of aminomethylated bead polymer to be tested are tamped in a tamp volumeter and then washed by demineralized water into a glass column. 1000 ml of 2% strength by weight sodium hydroxide solution are passed over the material during 1 hour and 40 minutes. Demineralized water is then passed over the material until 100 ml of eluate mixed with phenolphthalein consume not more than 0.05 ml of 0.1 N (0.1 normal) hydrochloric acid.

50 ml of this resin are mixed with 50 ml of demineralized water and 100 ml of 1 N hydrochloric acid in a glass beaker. The suspension is stirred for 30 minutes and then charged to a glass column. The liquid flows out at the bottom. A further 100 ml of 1 N hydrochloric acid are passed over the resin during 20 minutes. 200 ml of methanol are then passed over the material. All of the eluates are collected and combined and titrated with 1 N sodium hydroxide solution using methyl orange.

The amount of aminomethyl groups in 1 liter of aminomethylated resin is calculated by the following formula: (200−V)·20=mol of aminomethyl groups per liter of resin.

What is claimed is:

1. A process for preparing heterodisperse chelating resins comprising
(a) reacting monomer droplets made from at least one monovinylaromatic compound and at least one polyvinylaromatic compound, from a porogen, and from an initiator or an initiator combination, wherein the initiator is a peroxycarbonate, a perester, or a peroxyester, to give a heterodisperse crosslinked bead polymer,
(b) amidomethylating the heterodisperse crosslinked bead polymer with a phthalimide derivative,
(c) reacting the amidomethylated bead polymer is reacted an amino-methylated bead polymer, and
(d) functionalizing the aminomethylated bead polymer to give a bead polymer containing chelating groups.

2. A process according to claim 1 additionally comprising, after step (d), converting the heterodisperse chelating resin by means of a base.

3. A process according to claim I wherein step (a) is carried out in the presence of a protective colloid.

4. A process according to claim 3 wherein the protective colloid is gelatin, starch, polyvinyl alcohol, polyvinylpyrrolidone, polyacrylic acid, polymethacrylic acid, or a copolymer of (meth)acrylic acid or a (meth)acrylic ester.

5. A process according to claim I wherein the monovinylaromatic compound is a monoethylenically unsaturated compound.

6. A process according to claim 1 wherein the polyvinylaromatic compound is divinylbenzene, divinyltoluene, trivinylbenzene, divinylnaphthaline, trivinylnaphthaline, 1,7-octadiene, 1,5-hexadiene, ethylene glycol dimethacrylate, trimethylolpropane trimethacrylate, or allyl methacrylate.

7. A process according to claim I wherein step (b) begins by forming a phthalimido ether.

8. A process according to claim 7 wherein the phthalimido ether is prepared by reacting phthalimide and formalin.

9. A process according to claim 7 wherein the reaction of the phthalimido ether with the bead polymer takes place in the presence of oleum, sulfuric acid, or sulfur trioxide.

10. A process according to claim I wherein step (d) uses a compound that gives the functionalized amine chelating properties.

11. A heterodisperse chelating resin obtained by a process comprising
(a) reacting monomer droplets made from at least one monovinylaromatic compound and at least one polyvinylaromatic compound, from a porogen, and from an initiator or an initiator combination, wherein the initiator is a peroxycarbonate, a perester, or a peroxyester, to give a heterodisperse crosslinked bead polymer,
(b) amidomethylating the heterodisperse crosslinked bead polymer with a phthalimide derivative,
(c) reacting the amidomethylated bead polymer to give an aminomethylated bead polymer, and
(d) functionalizing the aminomethylated bead polymer to give a chelating resin.

12. A heterodisperse chelating resin according to claim 11, characterized in that chelating groups of the formula (I)
—(CH₂)ₙ—NR₁R₂ (I)
where
R₁ represents hydrogen, CH₂—COOH, CH₂P(O)(OH)₂, or 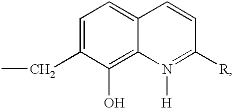
R₂ represents CH₂COOH, CH₂P(O)(OH)₂, 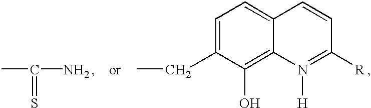
n represents the integer 1, 2, 3, or 4, and
R represents hydrogen or a branched or unbranched alkyl radical having up to 12 carbon atoms, form during step (d) of the process.

13. A heterodisperse chelating resin according to claim 11 wherein the process additionally comprises, after step (d), converting the heterodisperse chelating resin by means of a base.

14. A chelating resin according to claim 11 having a macroporous structure.

15. A composition useful in metallurgy comprising a chelating resin according to claim 11 in the form prepared or as a powder resin, paste, or compound.

16. A process comprising removing alkaline earth metals, heavy metals, or precious metals from aqueous solutions or vapors, aqueous solutions of alkaline earth metals or of alkali metals, saline solutions from alkali metal chloride electrolysis, from aqueous hydrochloric acid, from waste water, from flue gas scrubber effluent, or from ground water or landfill run-off, from liquid or gaseous hydrocarbons, from carboxylic acids, or from liquid or gaseous halogenated hydrocarbons using a chelating resin according to claim 11.

17. A process according to claim 16 wherein the alkaline earth metals removed are beryllium, magnesium, calcium, strontium, or barium, and the heavy metals or precious metals removed are mercury, iron, cobalt, nickel, copper, zinc, lead, cadmium, manganese, uranium, vanadium, elements of the platinum group, gold, or silver.

18. A process comprising removing magnesium, calcium, strontium, barium, beryllium, rhodium, elements of the platinum group, catalyst residues comprising precious metal or rhodium, gold, or silver from organic solutions or solvents using a chelating resin according to claim 11.

19. A process comprising removing heavy metals from substances converted during electrolytic treatment using a chelating resin according to claim 11.

20. A process comprising removing alkaline earth metals from saline solutions derived from alkali metal chloride hydrolysis using a chelating resin according to claim 11.

21. A process comprising removing antimony, iron, cobalt, silver, tin or nickel in batteries using a chelating resin according to claim 11.

22. A process comprising removing gallium from sodium aluminate solutions.

23. A process comprising removing germanium from acidic aqueous solutions.
